(19) United States
(12) Patent Application Publication
(10) Pub. No.: US 2025/0391263 A1
(43) Pub. Date: Dec. 25, 2025

(54) Visual Alarm Device And Method For Detecting Visual Alarm Device

(71) Applicant: Siemens Schweiz AG, Zürich (CH)

(72) Inventors: Shao Chen Lin, BSCE, Beijing (CN); Roland Schenkel, Bubikon (CH)

(73) Assignee: Siemens Schweiz AG, Zürich (CH)

(21) Appl. No.: 18/879,491

(22) PCT Filed: Jun. 22, 2023
(86) PCT No.: PCT/IB2023/056461

§ 371 Date: Dec. 27, 2024

(30) Foreign Application Priority Data
Jun. 29, 2022 (CN) 202210750439.0

(51) Int. Cl. G08B 29/10; G08B 5/38

(52) U.S. Cl. CPC G08B 29/10; G08B 5/38

(57) ABSTRACT

Various embodiments of the teachings herein include a method for detecting whether a visual alarm device is blocked. The visual alarm device comprises a light source located on an inner side of a lens. An example method includes: obtaining an illuminance signal indicating a light intensity of light from the lens side when the light source is emitting light; and sending a first fault signal to a management terminal if it is determined that the light intensity of the light from the lens side is greater than a first illuminance threshold according to the illuminance signal. The first fault signal indicates the visual alarm device is blocked.

### CROSS-REFERENCE TO RELATED APPLICATIONS

This application is a U.S. National Stage Application of International Application No. PCT/IB2023/056461 filed Jun. 22, 2023, which designates the United States of America, and claims priority to CN application No. 202210750439.0 filed Jun. 29, 2022, the contents of which are hereby incorporated by reference in their entirety.

### TECHNICAL FIELD

The present application relates to fire protection. Various embodiments of the teachings herein include visual alarm devices, methods for detecting a visual alarm device, electronic devices, and storage media.

### BACKGROUND

Visual alarm devices are a kind of fire alarm equipment. When a fire occurs, a visual alarm device flashes to alert people to escape and evacuate. It is an important way for hearing-impaired people to obtain fire alarm information. Visual alarm devices are usually installed on the ceiling or walls, and may be blocked during use, resulting in failure of the flashing light to provide an effective warning. For example, dust, coatings or other objects on visual alarm devices will affect the alarm effect of the devices. Therefore, it is necessary to test visual alarm devices to determine whether they can send alarms normally.

US 2006/0001547 A1 discloses an operational status detection system for a railroad warning device having a warning light. The warning light comprises: a photodiode configured to generate a signal corresponding to a light output of the warning light of the railroad warning device; an amplifier for increasing a signal strength of the signal and providing an output corresponding to the signal; a filter for receiving the output, the filter being configured to only allow portions of the output corresponding to the light output of the warning light to be presented as an output signal of the warning light; and a microcontroller receptive to the output signal and for comparing the output signal to a threshold value, the threshold value corresponding to an acceptable light output of the warning light.

US 2010/0231414 A1 discloses a signal alignment monitoring system. The system includes a signal assembly including at least one signal lamp. The system also includes an alignment monitoring apparatus coupled to the signal assembly. The alignment monitoring apparatus includes a source for emitting electromagnetic energy and a detector for sensing electromagnetic energy emitted by the source to facilitate determining an alignment of the signal assembly.

At present, it is necessary for the operator to regularly go to the sites to inspect visual alarm devices and check each device one by one to see if it is blocked, to ensure that all the visual alarm devices can give an effective alarm when a fire occurs. However, since a large number of visual alarm devices are installed in large buildings such as factories, shopping malls, office buildings, etc., it takes a long time for the operator to inspect each device in the field, and it is necessary to use ladders, lifting equipment, etc., to complete the inspection of devices installed at height, resulting in poor user experience of visual alarm devices.

### SUMMARY

In view of the above, the teachings of the present disclosure include visual alarm devices and methods for detecting a visual alarm device, electronic device and storage medium provided which can improve user experience of visual alarm devices. For example, some embodiments of the teachings herein include a visual alarm device comprising: a light source, a lens, a processing module and a light sensing module; the light source and the light sensing module are both located on an inner side of the lens, and the processing module is connected to the light sensing module; the lens is constructed to transmit light emitted by the light source; the light sensing module is used to sense the light from the lens side when the light source is turned on, generate an illuminance signal used to indicate the light intensity of the sensed light, and send the illuminance signal to the processing module; the processing module is used to send a first fault signal to a management terminal when it is determined that the light intensity sensed by the sensing module is greater than a first illuminance threshold according to the illuminance signal, wherein the first fault signal is used to indicate that the visual alarm device is blocked.

In some embodiments, the light from the lens side comprises at least one of: light reflected from an inner surface of the lens, light emitted from an outer surface of the lens, and light transmitted from an outer side of the lens to the inner side of the lens.

In some embodiments, the processing module is also used to send a second fault signal to the management terminal when it is determined that the light intensity sensed by the sensing module is smaller than a second illuminance threshold according to the illuminance signal, wherein the second illuminance threshold is smaller than the first illuminance threshold, and the second fault signal is used to indicate that the light source is faulty.

In some embodiments, the light sensing module comprises: at least two light sensors; the at least two light sensors are arranged at different positions on the inner side of the lens, and the at least two light sensors are respectively connected to the processing module; the at least two light sensors are used to respectively sense light from the lens side when the light source is turned on, generate an illuminance signal used to indicate a light intensity of the sensed light, and send the generated illuminance signal to the processing module; the processing module is used to send the first fault signal to the management terminal when the light intensity indicated by the illuminance signal sent by at least one of the light sensors is greater than the first illuminance threshold, and send the second fault signal to the management terminal when the light intensities indicated by the illuminance signals sent by both of the light sensors are smaller than the second illuminance threshold.

In some embodiments, the outer side of the lens is a convex surface, the inner side of the lens is provided with a cross-shaped concave portion, the concave portion comprises a first groove and a second groove that are orthogonal, and the light source is arranged in a cavity where the first groove and the second groove intersect; the inner side of the lens comprises four refraction regions located between the first groove and the second groove, and each of the refraction regions is provided with at least one of the light sensors.

In some embodiments, one of the light sensors is arranged on each of the refraction regions, and a light sensing surface of the light sensors faces the outer side of the lens; for each of the light sensors, the angle between the vertical line passing through the center of the light sensing surface of the light sensor and perpendicular to the light sensing surface and the normal at the point of intersection where the vertical line and the outer surface of the lens intersect is less than 15°.

In some embodiments, the light sensing module comprises: an annular light sensor; the light source is arranged in the annular ring of the annular light sensor, and a light sensing surface of the annular light sensor faces the outer side of the lens.

In some embodiments, the light sensing module comprises: a DC power supply, a light sensor, an operational amplifier, a first resistor, a second resistor, a third resistor and an analog-to-digital converter; the DC power supply is connected to the input terminal of the light sensor, the output terminal of the light sensor is connected to the input terminal of the first resistor, and the output terminal of the first resistor is grounded; the non-inverting input terminal of the operational amplifier is connected to the output terminal of the light sensor, the inverting input terminal of the operational amplifier is connected to the input terminal of the second resistor, and the output terminal of the second resistor is grounded; the input terminal of the third resistor is connected to the output terminal of the operational amplifier, and the output terminal of the third resistor is connected to the input terminal of the second resistor; the output terminal of the operational amplifier is connected to the input terminal of the analog-to-digital converter, and the output terminal of the analog-to-digital converter is connected to the processing module.

As another example, some embodiments include a method for detecting a visual alarm device used to detect whether a visual alarm device is blocked, the visual alarm device comprising a light source and a lens, the light source being located on the inner side of the lens, and the method for detecting a visual alarm device comprising: obtaining an illuminance signal used to indicate the light intensity of light from the lens side when the light source is turned on; sending a first fault signal to a management terminal when it is determined that the light intensity of the light from the lens side is greater than a first illuminance threshold according to the illuminance signal, wherein the first fault signal is used to indicate that the visual alarm device is blocked.

In some embodiments, the method for detecting a visual alarm device further comprises: sending a second fault signal to the management terminal when it is determined that the light intensity of the light from the lens side is smaller than a second illuminance threshold according to the illuminance signal, wherein the second illuminance threshold is smaller than the first illuminance threshold, and the second fault signal is used to indicate that the light source is faulty.

As another example, some embodiments include an electronic device comprising: a processor, a communication interface, a memory, and a communication bus, t the processor, the memory and the communication interface communicating with each other via the communication bus; the memory is used to store at least one executable instruction, and the executable instruction causes the processor to perform the operations corresponding to one or more of the methods for detecting a visual alarm device described herein.

As another example, some embodiments include a computer-readable medium storing a computer program, which, when executed by a processor, causes the processor to perform the operations corresponding to one or more of the methods for detecting a visual alarm device provided in the first aspect described herein.

As another example, some embodiments include a computer program product stored on a tangible computer-readable medium and comprises a computer-executable instruction which, when executed, causes at least one processor to perform one or more of the methods for detecting a visual alarm device described herein.

### BRIEF DESCRIPTION OF THE DRAWINGS

FIG. 1 is a schematic diagram of an example visual alarm device incorporating teachings of the present disclosure;

FIG. 2 is a schematic diagram of another example visual alarm device incorporating teachings of the present disclosure;

FIG. 3 is a schematic diagram of an example lens incorporating teachings of the present disclosure;

FIG. 4 is a schematic diagram of relative positions of the light sensor and an example lens incorporating teachings of the present disclosure;

FIG. 5 is a schematic diagram of relative positions of the light sensor of another type and an example lens incorporating teachings of the present disclosure;

FIG. 6 is a schematic structural diagram of the circuit of a light sensing module incorporating teachings of the present disclosure;

FIG. 7 is a flowchart of an example method for detecting a visual alarm device incorporating teachings of the present disclosure;

FIG. 8 is a flowchart of another example method for detecting a visual alarm device incorporating teachings of the present disclosure;

FIG. 9 is a schematic diagram of an example electronic device incorporating teachings of the present disclosure.

### NUMERALS IN THE DRAWINGS

| | | |
|---|---|---|
| 10: Visual alarm | 20: Management | 1: Light source |
| device | terminal | |
| 2: Lens | 3: Processing module | 4: Light sensing module |
| 31: Light sensor | 21: Concave portion | 211: First groove |
| 212: Second groove | 213: Cavity | 214: Refraction region |
| 311: Light sensing | V: DC power supply | F: Operational amplifier |
| surface | | |
| R1: First resistor | R2: Second resistor | R3: Third resistor |
| AD: Analog-to-digital | 400: Electronic device | 402: Processor |
| converter | | |
| 404: Communication | 406: Memory | 408: Communication bus |
| interface | | |
| 410: Program | θ: Angle | 5: Printed circuit board |

S101: obtaining an illuminance signal used to indicate the light intensity of light from the lens side when the light source is turned on
S102: sending a first fault signal to a management terminal when it is determined that the light intensity of the light from the lens side is greater than a first illuminance threshold according to the illuminance signal
S201: obtaining an illuminance signal used to indicate the light intensity of light from the lens side when the light source is turned on
S202: determining whether the light intensity of the light from the lens side is greater than or equal to a second illuminance threshold according to the illuminance signal
S203: sending a second fault signal to the management terminal
S204: determining whether the light intensity of the light from the lens side is smaller than or equal to a first illuminance threshold according to the illuminance signal
S205: sending a first fault signal to a management terminal, wherein the first fault signal is used to indicate that the visual alarm device is blocked
S206: sending a signal used to indicate that the visual alarm device is working normally to the management terminal

### DETAILED DESCRIPTION

A visual alarm device incorporating teachings of the present disclosure comprises a light source, a lens, a processing module, and a light sensing module, the light sensing module can sense the light from the lens side when the light source is turned on, generate an illuminance signal used to indicate the light intensity of the sensed light, and send the illuminance signal to the processing module, and the processing module can send a first fault signal to a management terminal when it is determined that the light intensity of the light sensed by the light sensing module is greater than a first illuminance threshold according to the illuminance signal, and the first fault signal can be used to indicate that the visual alarm device is blocked. In this way, the visual alarm device in the examples of the present application can realize effective feedback to the management terminal when it is blocked by dust, a coating or other objects on its surface, so that an operator can know the status of the visual alarm device being blocked through the management terminal, and is thus able to accurately locate blocked visual alarm devices during inspection of the devices, without the need to check each of a large number of visual alarm devices, thereby preventing wasting of the operator's time; for visual alarm devices installed at special locations (for example, at height), the operator can inspect the devices without the need for other tools (for example, ladders, lifting equipment, etc.), thereby improving user experience of visual alarm devices; in addition, since the examples of the present application can facilitate accurate determination, by an operator, of whether a visual alarm device is blocked, it is also easy for the operator to take timely actions for the visual alarm devices that cannot send an alarm because they are blocked, thereby ensuring the alarm effect of the visual alarm devices.

As described previously, visual alarm devices are a kind of fire alarm equipment. When a fire occurs, a visual alarm device flashes to alert people to escape and evacuate. It is an important way for hearing-impaired people to obtain fire alarm information. Visual alarm devices are usually installed on the ceiling or walls, and may be blocked during use, resulting in failure of the emitted flashing light to provide an effective warning. For example, dust, coatings or other objects on visual alarm devices will affect the alarm effect of the devices. Therefore, it is necessary to test visual alarm devices to determine whether they can send alarms normally. At present, it is necessary for the operator to regularly go to the sites to inspect visual alarm devices and check each device one by one to see if it is blocked, to ensure that all the visual alarm devices can give an effective alarm when a fire occurs. However, since a large number of visual alarm devices are installed in large buildings such as factories, shopping malls, office buildings, etc., it takes a long time for the operator to inspect each device in the field, and it is necessary to use ladders, lifting equipment, etc., to complete the inspection of devices installed at height, resulting in poor user experience of visual alarm devices.

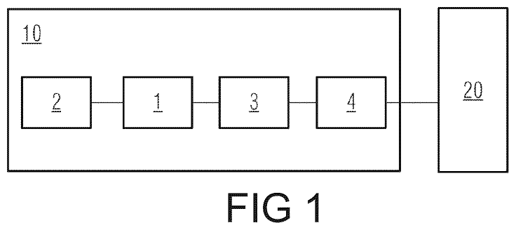

In view of this, with reference to FIG. 1, a visual alarm device 10 can at least partially address the above problems. The visual alarm device 10 comprises: a light source 1, a lens 2, a processing module 4 and a light sensing module 3; the light source 1 and the light sensing module 3 are both located on the inner side of the lens 2, and the processing module 4 is connected to the light sensing module 3; the lens 2 is constructed to transmit light emitted by the light source 1; the light sensing module 3 is used to sense the light from the lens 2 side when the light source 1 is turned on, generate an illuminance signal used to indicate the light intensity of the sensed light, and send the illuminance signal to the processing module 4; the processing module 4 is used to send a first fault signal to a management terminal 20 when it is determined that the light intensity sensed by the sensing module 3 is greater than a first illuminance threshold according to the illuminance signal, wherein the first fault signal is used to indicate that the visual alarm device 10 is blocked.

The visual alarm device 10 comprises a light source 1, a lens 2, a processing module 4 and a light sensing module 3, wherein the light sensing module 3 can sense the light from the lens 2 side when the light source 1 is turned on, generate an illuminance signal used to indicate the light intensity of the sensed light, and send the illuminance signal to the processing module 4, the processing module 4 can send a first fault signal to a management terminal 20 when it is determined that the light intensity of the light sensed by the light sensing module 3 is greater than a first illuminance threshold according to the illuminance signal, and the first fault signal can be used to indicate that the visual alarm device is blocked; thus, the visual alarm device in the examples of the present application can realize effective feedback to the management terminal when it is blocked by dust, a coating or other objects on its surface, and the operator can know the status of the visual alarm device being blocked through the management terminal, and is thus able to accurately locate blocked visual alarm devices during inspection of the devices, without the need to check each of a large number of visual alarm devices, thereby preventing wasting of the operator's time; for visual alarm devices installed at special locations (for example, at height), the operator can inspect the devices without the need for other tools (for example, ladders, lifting equipment, etc.), thereby improving user experience of visual alarm devices; in addition, since the these can facilitate accurate determination, by an operator, of whether a visual alarm device is blocked, it is also easy for the operator to take timely actions for the visual alarm devices that cannot send an alarm because they are blocked, thereby ensuring the alarm effect of the visual alarm devices.

In some embodiments, the light from the lens 2 side comprises at least one of the following: light reflected from the inner surface of the lens 2, light emitted from the outer surface of the lens 2, and light transmitted from the outer side of the lens 2 to the inner side of the lens 2.

The light source 1 is located on the inner side of the lens 2. When the light emitted by the light source 1 passes through the lens 2, the inner and outer surfaces of the lens 2 will both reflect the light emitted by the light source 1, and the amount of the reflected light can indicate the light transmission of the lens 2. For example, when the outer surface of the lens 2 is dirty or the lens 2 is damaged, the amount of light transmitted by the lens 2 will be reduced, thereby reducing the light reflected by the lens 2 to the light sensing module 3. When an obstacle, for example, a wardrobe, at the outer side of the lens 2 blocks the visual alarm device 10, the light emitted by the light source 1 through the lens 2 is reflected by the obstacle, and the reflected light is transmitted from the outer side of the lens 2 to the inner side of the lens 2, thereby increasing the intensity of the light sensed by the light sensing module 3, and thus the light intensity of the light sensed by the light sensing module 3 can also indicate whether the lens 2 is blocked by an external obstacle.

In some embodiments, the light from the lens 2 side comprises the light reflected by the inner surface of the lens 2, the light reflected by the outer surface of the lens 2, and the light transmitted from the outer side of the lens 2 to the inner side of the lens 2, and therefore the intensity of the light sensed by the light sensing module 3 can indicate soiling on the surface of the lens 2, damage to the lens 2, blocking of the lens 2 by external obstacles, etc., thereby improving the accuracy of fault detection of the visual alarm device 10.

Various example visual alarm devices 10 incorporating teachings of the present disclosure are described in detail below in conjunction with the drawings. It should be understood that the description below is not intended as any limitation of the scope of protection of the present disclosure.

In some embodiments, the light source 1 of the visual alarm device 10 may be a light-emitting element arranged on the inner side of the lens 2, and the specific configuration is not limited here. For example, in some examples, the light source 1 comprises LED lamps or LED lamp arrays. When a situation that needs an alarm to be sent occurs during the operation of the visual alarm device 10, the light source 1 emits light to give an alarm. For example, the light source 1 can strobe when emitting light, so that the visual alarm device 10 functions as an alarm.

The lens 2 is used to transmit the light emitted by the light source 1. In some embodiments, the specific structure and shape of the lens 2 are not limited, as long as the requirements can be met. When the light emitted by the light source 1 is output through the lens 2, the shape of the light spot formed by the light emitted by the light source 1 can be adjusted by adjusting the lens 2, and thus the visual alarm effect of the visual alarm device 10 can be adjusted with different structures of the lens 2 or different installation methods of the lens 2.

The specific structure of the light sensing module 3 is not limited. For example, the light sensing module 3 may comprise one or more light sensing elements, which can sense the light from the lens 2 side when the light source 1 is turned on.

It can be understood that the state in which the light source 1 is turned on refers to the state in which the light source 1 emits light to the outside. Specifically, the light reflected by the lens 2 may refer to the part of the light emitted by the light source 1 that reaches a surface of the lens 2 (for example, the inner surface and the outer surface of the lens 2) and is reflected by the surface of the lens 2 when the light source 1 is turned on; the light transmitted to the inner side of the lens 2 may refer to the part of light that firstly passes through the lens 2 from the inside to the outside to reach an external object and is then reflected back by the surface of the external object and transmitted to the inner side of the lens 2 from the outside to the inside when the light source 1 is turned on, wherein the external object may be, for example, dust attached to the visual alarm device 10, a coating on the visual alarm device 10, or another object that blocks the visual alarm device 10, as described previously.

After sensing the light from the lens 2 side when the light source 1 is turned on, the light sensing module 3 can generate an illuminance signal used to indicate the light intensity of the sensed light. In optics, illuminance, also known as light intensity, refers to the luminous flux received per unit area on the surface of an illuminated object. In some embodiments, the light sensing module 3 generates an illuminance signal and sends it to the processing module 4, so that the processing module 4 performs analysis and processing according to the intensity of the light sensed by the light sensing module 3 indicated by the illuminance signal.

In some embodiments, the processing module 4 may comprise one or more processors for data processing, which may be, for example, a CPU, an MCU, an FPGA, a DSP, etc. The processing module 4 receives the illuminance signal sent by the light sensing module 3, determines the light intensity of the light sensed by the light sensing module 3 according to the illuminance signal, and sends the first fault signal used to indicate that the visual alarm device 10 is blocked to the management terminal 20 when the light intensity is greater than the first illuminance threshold. For example, the management terminal 20 may be a mobile phone, a computer, etc., of the operator that can be used to receive signals, so that the operator can know the status of the corresponding visual alarm device 10 being blocked.

Specifically, for a visual alarm device 10 that is blocked by an external object, more of the light emitted by the light source 1 will be reflected to the inside of the lens 2 by the external object, i.e. more light will be transmitted to the inner side of the lens 2, and as a result, the light intensity (for example, marked as the first light intensity) indicated by the illuminance signal generated by the light sensing module 3 is generally much higher than the light intensity (for example, marked as the second light intensity) indicated by an illuminance signal generated by the light sensing module 3 of a visual alarm device 10 that is not blocked by an external object. Based on this, by setting a first illuminance threshold, the processing module 4 can determine more accurately whether a visual alarm device 10 is blocked by comparing the first illuminance threshold with the light intensity of the light sensed by the light sensing module 3 which is determined according to the illuminance signal.

It should be noted that the first illuminance threshold may be configured as required, and the first illuminance threshold may be different for different visual alarm devices; this is not limited in any manner.

In some embodiments, the first fault signal may be sent to the management terminal 20 by the processing module 4 in the form of a character string, as long as it can indicate that the visual alarm device 10 is blocked; this is not limited by the present application. For example, the first fault signal may be manifested as: “Optical failure”, “Blocked”, “Visual alarm device blocked”, etc.

Based on this, the visual alarm device 10 in the present application realizes effective feedback to the management terminal 20 when the visual alarm device 10 is blocked by dust, a coating or other objects on its surface, and the operator can know the status of the visual alarm device 10 being blocked through the management terminal 20, and is thus able to accurately locate blocked visual alarm devices during inspection of the devices, without the need to check each of a large number of visual alarm devices, thereby preventing wasting of the operator's time; for visual alarm devices installed at special locations (for example, at height), the operator can inspect the devices without the need for other tools (for example, ladders, lifting equipment, etc.), thereby improving user experience of visual alarm devices; in addition, since the examples of the present application can facilitate accurate determination, by the operator, of whether a visual alarm device is blocked, it is also easy for the operator to take timely actions for the visual alarm devices that cannot send an alarm because they are blocked, thereby ensuring the alarm effect of the visual alarm devices 10.

In some embodiments, the processing module 4 of the visual alarm device 10 is also used to send a second fault signal to the management terminal 20 when it is determined that the light intensity sensed by the sensing module 3 is smaller than a second illuminance threshold according to the illuminance signal, wherein the second illuminance threshold is smaller than the first illuminance threshold, and the second fault signal is used to indicate that the light source 1 is faulty.

Based on this, effective feedback can be given to the management terminal when the light source 1 of the visual alarm device 10 has a fault and cannot work normally, and the operator can know through the management terminal 20 that the light source 1 of the corresponding visual alarm device 10 has failed, so that timely actions can be taken to fix the light source 1 of the visual alarm device 10, to ensure that the visual alarm device 10 can work normally and ensure the alarm effect of the visual alarm device 10.

Specifically, for a visual alarm device 10 whose light source 1 fails, it is difficult for the light source 1 to emit light to the outside normally, and as a result, the light intensity (for example, marked as the first light intensity) indicated by the illuminance signal generated by the light sensing module 3 is generally much lower than the light intensity (for example, marked as the second light intensity) indicated by an illuminance signal generated by the light sensing module 3 of a visual alarm device 10 whose light source 1 has not failed. Based on this, by setting a second illuminance threshold, the processing module 4 can determine more accurately whether the light source 1 of a visual alarm device 10 has failed by comparing the second illuminance threshold with the light intensity of the light sensed by the light sensing module 3 which is determined according to the illuminance signal.

It should be noted that the second illuminance threshold may be configured as required, and the second illuminance threshold may be different for different visual alarm devices 10 and different light sources 1; this is not limited in the examples of the present application in any manner.

In some embodiments, the second fault signal may be sent to the management terminal 20 by the processing module 4 in the form of a character string, as long as it can indicate that the light source 1 is faulty; this is not limited by the present application. For example, the second fault signal may be manifested as: “Light source failure”, “LED failure”, “External circuit failure”, etc.

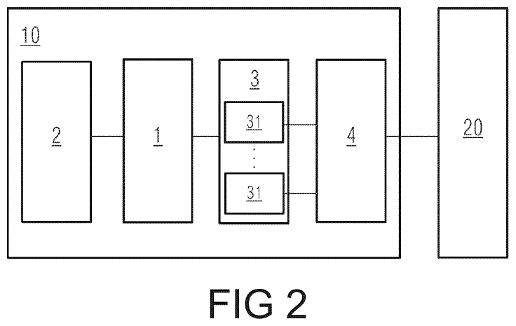

In some embodiments, the specific composition and structure of the light sensing module 3 are not limited, as long as the requirements can be met. Exemplarily, with reference to FIG. 2, in some optional examples, the light sensing module 3 of the visual alarm device 10 comprises: at least two light sensors 31; the at least two light sensors 31 are arranged at different positions on the inner side of the lens 2, and the at least two light sensors 31 are respectively connected to the processing module 4; the at least two light sensors 31 are used to respectively sense light from the lens 2 side when the light source 1 is turned on, generate an illuminance signal used to indicate the light intensity of the sensed light, and send the generated illuminance signal to the processing module 4; the processing module 4 is used to send the first fault signal to the management terminal 20 when the light intensity indicated by the illuminance signal sent by at least one of the light sensors 31 is greater than the first illuminance threshold, and send the second fault signal to the management terminal 20 when the light intensities indicated by the illuminance signals sent by both of the light sensors 31 are smaller than the second illuminance threshold.

The type of the light sensors 31 is not limited in any manner in the examples of the present application. For example, the light sensors 31 may comprise at least one light sensing element described previously.

Through such a structure of the light sensing module 3, it can be ensured that the illuminance signal generated thereby can accurately indicate the light intensity of the light sensed by the light sensing module 3, so that the processing module 4 can accurately send the first fault signal or the second fault signal to the management terminal 20 according to the light intensity indicated by the illuminance signal, thereby accurately feeding back to the management terminal 20 the result that the visual alarm device 10 is blocked or the light source 1 is faulty, so that the operator can take actions for the visual alarm device 10 in time to ensure the alarm effect of the visual alarm device 10.

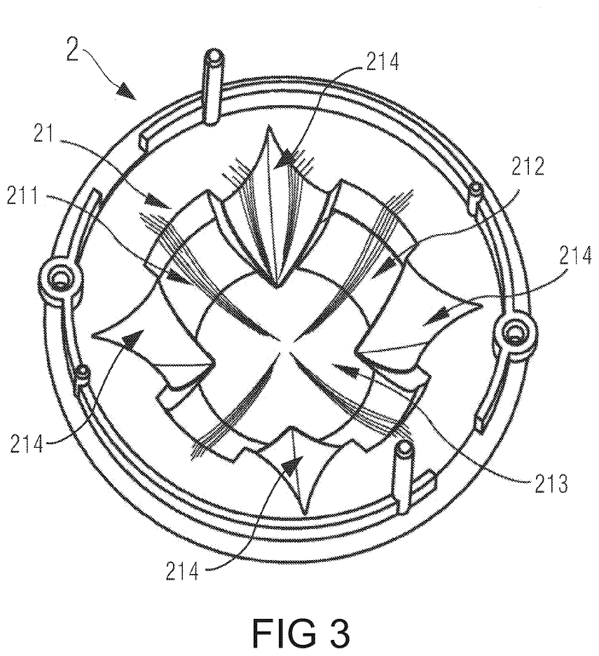

In some embodiments, the specific composition and structure of the lens 2 are not limited, and the specific positions of the at least two light sensors 31 on the inner side of the lens 2 are not limited either, as long as the requirements can be met. In some embodiments, with reference to FIG. 3, in some optional examples, the outer side of the lens 2 of the visual alarm device 10 is a convex surface, the inner side of the lens 2 is provided with a cross-shaped concave portion 21, the concave portion 21 comprises a first groove 211 and a second groove 212 that are orthogonal, and the light source 1 is arranged in a cavity 213 where the first groove 211 and the second groove 212 intersect; the inner side of the lens 2 comprises four refraction regions 214 located between the first groove 211 and the second groove 212, and each of the refraction regions 214 is provided with at least one of the light sensors 31.

With reference to FIG. 3, the outer side of the lens 2 may be the side of the lens 2 remote from the light source 1, and the inner side of the lens 2 may be the side close to the light source 1. The sizes of the orthogonal first groove 211 and second groove 212 may be the same in some examples and may also be different in other examples; this is not particularly limited here.

Based on such a structure, the accuracy of the light sensor 31 sensing the light from the lens 2 side when the light source 1 is turned on can be better ensured, so that the generated illuminance signal can accurately indicate the intensity of the light, so that the processing module 4 can make a decision according to the illuminance signal and give accurate feedback to the management terminal 20.

In some embodiments, in the visual alarm device 10, one of the light sensors 31 is arranged on each of the refraction regions 214, and the light sensing surface 311 of the light sensors 31 faces the outside of the lens 2; for each of the light sensors 31, the angle θ between the vertical line passing through the center of the light sensing surface 311 of the light sensor 31 and perpendicular to the light sensing surface 311 and the normal at the point of intersection where the vertical line and the outer surface of the lens 2 intersect is less than 15°.

Specifically, the light sensing surface 311 of the light sensors 31 faces the outside of the lens 2, so that the light sensing surface 311 can sense the light from the lens 2 side when the light source 1 is turned on.

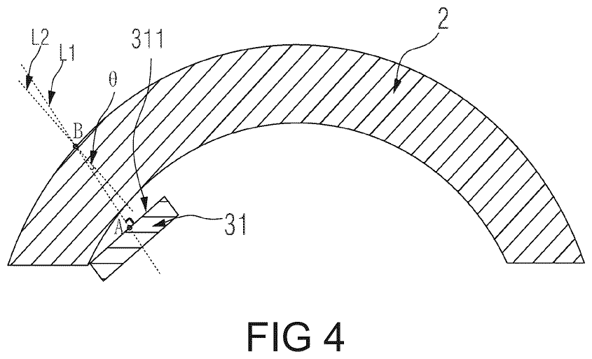

In addition, when understood with reference to the schematic sectional diagram FIG. 4, which schematically shows the angle θ between the vertical line L1 passing through the center A of the light sensing surface 311 of the light sensor 31 and perpendicular to the light sensing surface 311 and the normal L2 at the intersection B between the vertical line L1 and the outer surface of the lens 2, when the angle θ is smaller than 15°, more of the light from the lens 2 side when the light source 1 is turned on can be reflected to the light sensing surface 311 of the light sensor 31, and in this case, the light sensing surface 311 of the light sensor 31 can sense light more accurately, such that the generated illuminance signal can indicate the intensity of the light more accurately, so that the processing module 4 can make a decision according to the illuminance signal and give accurate feedback to the management terminal 20.

In some embodiments, for each of the light sensors 31, the angle between the vertical line passing through the center of the light sensing surface of the light sensor 31 and perpendicular to the light sensing surface and the normal at the intersection between the vertical line and the outer surface of the lens 2 is equal to 0°, i.e. the vertical line coincides with the normal. In this case, the accuracy of light sensing by the light sensing surface 311 of the light sensor 31 is improved, so that the generated illuminance signal can accurately indicate the intensity of the light, so that the processing module 4 can make a decision according to the illuminance signal and give accurate feedback to the management terminal 20.

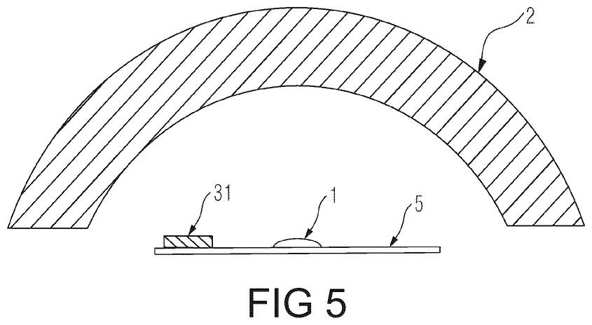

In some embodiments, as shown in FIG. 5, the light source 1 and the light sensor 31 are both arranged on a printed circuit board 5, the printed circuit board 5 is perpendicular to the central axis of the lens 2, the light sensing surface of the light sensor 31 is parallel to the printed circuit board 5, and the light sensor 31 is arranged at a position farther away from the light source 1, for example, at the edge region of the printed circuit board 5.

In some embodiments, the light source 1 and the light sensor 31 are both arranged on a printed circuit board 5, the printed circuit board 5 is perpendicular to the central axis of the lens 2, and the light sensing surface of the light sensor 31 is parallel to the printed circuit board 5, which can reduce blocking, by the light sensor 31, of the light emitted by the light source 1 and ensure the alarm effect of the visual alarm device 10. The light sensor 31 is arranged at a position farther away from the light source 1 to prevent or reduce perpendicular incidence of the light emitted by the light source 1 onto the light sensing surface of the light sensor 31, thereby ensuring the accuracy of detecting whether the visual alarm device 10 is blocked.

It should be noted that, on the basis of the visual alarm device 10 as shown in FIG. 5, there may be a plurality of the light sensors 31, and the light sensing surface of each light sensor 31 is parallel to the printed circuit board 5. The printed circuit board 5 is used to supply power to the light source 1 and each of the light sensors 31, transmit communication data between the light sensors 31 and the processing module 4, and fix the light source 1 and each of the light sensors 31.

In some embodiments, the light sensing module 3 in the visual alarm device 10 comprises: an annular light sensor; the light source 1 is arranged in the annular ring of the annular light sensor, and the light sensing surface of the annular light sensor faces the outside of the lens 2.

In some embodiments, the light sensing surface of the annular light sensors faces the outside of the lens 2, so that it can sense the light from the lens 2 side when the light source 1 is turned on.

In some embodiments, the light sensing module 3 uses an annular light sensor to sense light, and the sensed light is more uniform, so that the illuminance signal generated by the light sensing module 3 can more accurately indicate the intensity of the sensed light. In addition, because the light source 1 is arranged in the annular ring of the annular light sensor, the internal structure of the visual alarm device 10 in the examples of the present application is more compact, the space utilization is more reasonable, and the overall structure is more stable.

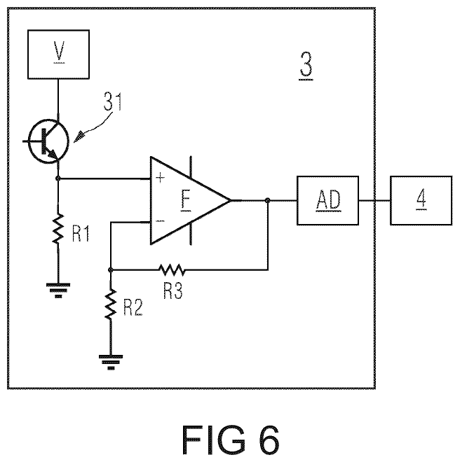

The circuit structure of the light sensing module 3 is not particularly limited in the examples of the present application, as long as the function can be realized. Exemplarily, in some optional examples, with reference to FIG. 6, the light sensing module 3 comprises: a DC power supply V, a light sensor 31, an operational amplifier F, a first resistor R1, a second resistor R2, a third resistor R3 and an analog-to-digital converter AD; the DC power supply V is connected to the input terminal of the light sensor 31, the output terminal of the light sensor 31 is connected to the input terminal of the first resistor R1, and the output terminal of the first resistor R1 is grounded; the non-inverting input terminal of the operational amplifier F is connected to the output terminal of the light sensor 31, the inverting input terminal of the operational amplifier F is connected to the input terminal of the second resistor R2, and the output terminal of the second resistor R2 is grounded; the input terminal of the third resistor R3 is connected to the output terminal of the operational amplifier F, and the output terminal of the third resistor R3 is connected to the input terminal of the second resistor R2; the output terminal of the operational amplifier F is connected to the input terminal of the analog-to-digital converter AD, and the output terminal of the analog-to-digital converter AD is connected to the processing module 4.

In some embodiments, the light sensor 31 may comprise an element whose resistance changes based on the intensity of the sensed light, for example, a photoresistor, a phototransistor, etc. in some examples. With reference to FIG. 6, this shows an example where the light sensor 31 is a phototransistor (the specific model is not limited here, e.g. it may be a TEMT6000 photosensitive sensor in one example), but it should be understood that the teachings herein are not limited thereto.

When the resistance value of the light sensor 31 changes with the intensity of the light, the voltage at its output terminal will also change accordingly, and there is a corresponding relationship between the voltage at the output terminal and the intensity of the light, so that the voltage at the output terminal can be used to measure the intensity of the light. The operational amplifier F, the second resistor R2 and the third resistor R3 form an amplifying circuit, which can amplify the voltage at the output terminal and then input it into the analog-to-digital converter AD for analog-to-digital conversion. When the analog voltage signal is converted into a digital signal, there is also a corresponding relationship between the digital signal and analog voltage signal. Subsequently, the light sensor 31 can generate an illuminance signal based on the digital signal, and therefore the illuminance signal can accurately indicate the intensity of the light. It can be understood that, since the voltage at the output terminal is generally not high, the operational amplifier F, the second resistor R2 and the third resistor R3 form an amplifying circuit to amplify the voltage at the output terminal, so that the analog-to-digital converter AD can perform analog-to-digital conversion more accurately, thereby ensuring that the illuminance signal generated by the light sensor 31 can accurately indicate the intensity of the light.

Obviously, with such a circuit structure, since it can accurately ensure that the light sensor 31 of the light sensing module 3 senses the light and accurately generates an illuminance signal used to indicate the intensity of the light, the processing module 4 can accurately feed back the result that the visual alarm device 10 is blocked (or the light source 1 is faulty) to the management terminal 20, so that the operator can take actions for the visual alarm device 10 in time to ensure the alarm effect of the visual alarm device 10.

It should be understood that the above examples of the visual alarm device 10 are only used as some exemplary explanations and should not be regarded as any limitation to the scope of the present disclosure. It can be seen from the description above that the visual alarm device 10 in the examples of the present application comprises a light source 1, a lens 2, a processing module 4 and a light sensing module 3, wherein the light sensing module 3 can sense the light from the lens 2 side when the light source 1 is turned on, generate an illuminance signal used to indicate the light intensity of the sensed light, and send the illuminance signal to the processing module 4, the processing module 4 can send a first fault signal to a management terminal 20 when it is determined that the light intensity of the light sensed by the light sensing module 3 is greater than a first illuminance threshold according to the illuminance signal, and the first fault signal can be used to indicate that the visual alarm device is blocked, and therefore, the visual alarm device in the examples of the present application can realize effective feedback to the management terminal when it is blocked by dust, a coating or other objects on its surface, and the operator can know the status of the visual alarm device being blocked through the management terminal, and is thus able to accurately locate blocked visual alarm devices during inspection of the devices, without the need to check each of a large number of visual alarm devices, thereby preventing wasting of the operator's time; for visual alarm devices installed at special locations (for example, at height), the operator can inspect the devices without the need for other tools (for example, ladders, lifting equipment, etc.), thereby improving user experience of visual alarm devices; in addition, since the examples of the present application can facilitate accurate determination, by an operator, of whether a visual alarm device is blocked, it is also easy for the operator to take timely actions for the visual alarm devices that cannot send an alarm because they are blocked, thereby ensuring the alarm effect of the visual alarm devices.

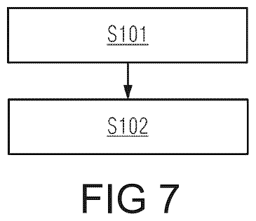

With reference to the flowchart shown in FIG. 7, an example method for detecting a visual alarm device may be used to detect whether a visual alarm device is blocked, the visual alarm device comprising a light source and a lens, the light source being located on the inner side of the lens, and the method for detecting a visual alarm device comprising S101 and S102, being specifically: S101: obtaining an illuminance signal used to indicate the light intensity of light from the lens side when the light source is turned on.
S102: sending a first fault signal to a management terminal when it is determined that the light intensity of the light from the lens side is greater than a first illuminance threshold according to the illuminance signal, wherein the first fault signal is used to indicate that the visual alarm device is blocked.

In some embodiments, the method for detecting a visual alarm device further comprises: sending a second fault signal to the management terminal when it is determined that the light intensity of the light from the lens side is smaller than a second illuminance threshold according to the illuminance signal, wherein the second illuminance threshold is smaller than the first illuminance threshold, and the second fault signal is used to indicate that the light source is faulty.

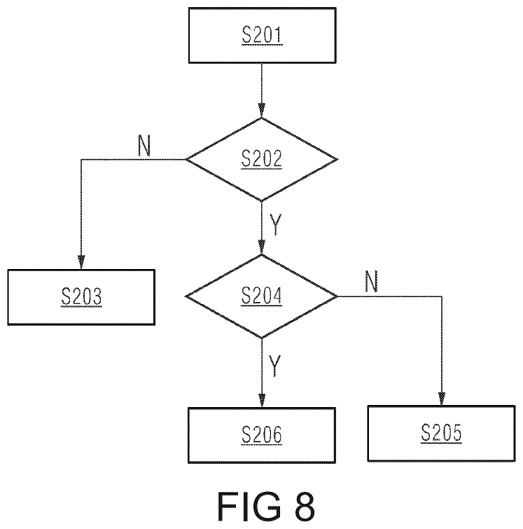

In some embodiments, with reference to the flowchart in FIG. 8, which is an overall flowchart of another exemplary method for detecting a visual alarm device in the examples of the present application, the method comprises:
S201: obtaining an illuminance signal used to indicate the light intensity of light from the lens side when the light source is turned on.
S202: determining whether the light intensity of the light from the lens side is greater than or equal to a second illuminance threshold according to the illuminance signal, wherein, if the answer is no, S203 is performed; if yes, S204 is performed.
S203: sending a second fault signal to a management terminal, wherein the second illuminance threshold is smaller than the first illuminance threshold, and the second fault signal is used to indicate that the light source is faulty.

For example, the second fault signal may be manifested as: “Light source failure”, “LED failure”, “External circuit failure”, etc.
S204: determining whether the light intensity of the light from the lens side is smaller than or equal to the first illuminance threshold according to the illuminance signal, wherein, if the answer is no, S205 is performed; if yes, S206 is performed.
S205: sending a first fault signal to a management terminal, wherein the first fault signal is used to indicate that the visual alarm device is blocked.

For example, the first fault signal may be manifested as: “Optical failure”, “Blocked”, “Visual alarm device blocked”, etc.
S206: sending a signal used to indicate that the visual alarm device is working normally to the management terminal.

For example, the signal used to indicate that the visual alarm device is normal may be manifested as: “Normal”, “Visual alarm device normal”, etc.

It can be seen from the description above that in the methods for detecting a visual alarm device, an illuminance signal used to indicate the intensity of the light from the lens side when the light source is turned on can be obtained, and a first fault signal can be sent to a management terminal when it is determined that the light intensity of the light from the lens side is greater than a first illuminance threshold according to the illuminance signal, and the first fault signal can be used to indicate that the visual alarm device is blocked, and therefore, when detecting whether a visual alarm device is blocked, effective feedback to the management terminal can be realized, so that the operator can know the status of the corresponding visual alarm device being blocked through the management terminal, and is thus able to accurately locate blocked visual alarm devices during inspection of the devices, without the need to check each of a large number of visual alarm devices, thereby preventing wasting of the operator's time; for visual alarm devices installed at special locations (for example, at height), the operator can inspect the devices without the need for other tools (for example, ladders, lifting equipment, etc.), thereby improving user experience of visual alarm devices; in addition, since the examples of the present application can facilitate accurate determination, by an operator, of whether a visual alarm device is blocked, it is also easy for the operator to take timely actions for the visual alarm devices that cannot send an alarm because they are blocked, thereby ensuring the alarm effect of the visual alarm devices.

It should be noted that the information interaction and execution process among the various units in the method for detecting a visual alarm device described above are based on the same idea as the product examples of the visual alarm device 10 described previously, and the particulars and benefits can be found in the description of the visual alarm device 10, which is not detailed here.

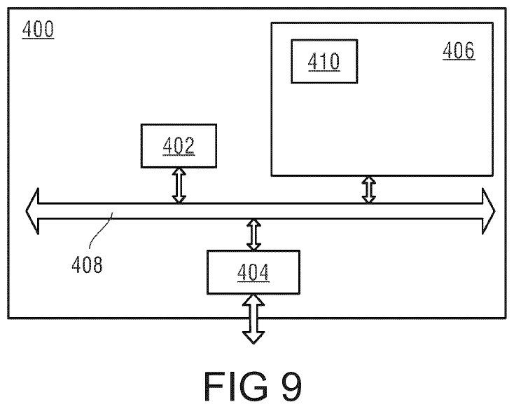

FIG. 9 is a schematic diagram of an example electronic device incorporating teachings of the present disclosure. The specific examples of the present application do not limit the specific implementation of the electronic devices. With reference to FIG. 9, the electronic device 400 comprises: a processor 402, a communication interface 404, a memory 406, and a communication bus 408. The processor 402, the communication interface 404 and the memory 406 communicate with each other via the communication bus 408.

The communication interface 404 is used for communicating with other electronic devices or servers.

The processor 402 is configured to execute the program 410, specifically, to execute the relevant steps in any of the examples of the method for detecting a visual alarm device described above. Specifically, the program 410 may comprise program code, which comprises computer operation instructions.

The processor 402 may be a central processing unit (CPU), or an application specific integrated circuit (ASIC), or one or more integrated circuits configured to implement the examples of the present application. One or more processors comprised in the smart device may be of the same type, for example, one or more CPUs; or of different types, for example, one or more CPUs and one or more ASICS.

The memory 406 is used to store a computer program 410. The memory 406 may comprise a high-speed RAM, and may further comprise a non-volatile memory, for example, at least one disk memory.

The program 410 may specifically be used to cause the processor 402 to execute the method for detecting a visual alarm device in any of the examples described above.

The description of the corresponding steps and units in any of the examples of the method for detecting a visual alarm device may be referred to for the specific implementation of each step in the program 410, which will not be detailed here. Those skilled in the art can clearly understand that, for the convenience and simplicity of the description, the corresponding process description in the method examples above may be referred to for the specific working process of the devices and modules described above, which will not be detailed here.

The examples of the present application also provide a computer-readable storage medium, which stores instructions for causing a machine to execute the method for detecting a visual alarm device as described herein. Specifically, a system or apparatus equipped with a storage medium may be provided; software program code realizing functions of any one of the embodiments above is stored on the storage medium, and a computer (or CPU or MPU) of the system or apparatus is caused to read and execute program code stored in the storage medium.

In this case, the program code read from the storage medium can implement the functions of any of the examples described above, and therefore the program code and the storage medium storing the program code constitute part of the present application.

Examples of storage media used for providing program code include floppy disks, hard disks, magneto-optical disks, optical disks (such as CD-ROM, CD-R, CD-RW, DVD-ROM, DVD-RAM, DVD-RW, DVD+RW), magnetic tapes, non-volatile memory cards and ROM. Optionally, program code may be downloaded from a server computer via a communication network.

Furthermore, it should be clear that an operating system operating on a computer can be made to complete a portion of or all actual operations, not only through execution of program code read by a computer, but also by means of instructions based on program code, so as to realize functions of any one of the embodiments above.

In addition, it can be understood that the program code read from the storage medium is written into a memory provided on an expansion board inserted into a computer or written into a memory provided in an expansion module connected to a computer, and then based on the instruction of the program code, the CPU, etc., installed on the expansion board or the expansion module performs part or all of the actual operations, thereby implementing the functions of any of the examples described above.

Some embodiments include a computer program product, which is stored on a tangible computer-readable medium and comprises a computer-executable instruction which, when executed, causes at least one processor to perform one or more of the methods for detecting a visual alarm device described above. It should be understood that the solutions in this example have the corresponding technical effects in the method examples described above, which will not be detailed here.

Not all of the steps and modules in the flows and system structure diagrams above are necessary; certain steps or modules may be omitted according to actual requirements. The sequence in which the steps are executed is not fixed but may be adjusted as needed. The system structures described in the embodiments above may be physical structures, and may also be logical structures, i.e. some modules might be realized by the same physical entity, or some modules might be realized by multiple physical entities, or realized jointly by certain components in multiple independent devices.

The description of the examples of the methods for detecting a visual alarm device, the electronic device, the computer-readable storage medium and the computer program product in the present application is relatively brief, and the various examples of the visual alarm device described previously may be referred to for understanding the relevant content and benefits, which will not be detailed here.

In the embodiments above, a hardware module may be realized in a mechanical or an electrical manner. For example, a hardware module may comprise permanently dedicated circuitry or logic (for example, a dedicated processor, an FPGA, or an ASIC) to perform the corresponding operations. The hardware module may further comprise programmable logic or circuitry (for example, a general-purpose processor or other programmable processors), which may be temporarily configured by software to complete the corresponding operations. Particular embodiments (mechanical, or dedicated permanent circuitry, or temporarily set circuitry) may be determined based on considerations of cost and time.

The present application has been demonstrated and described in detail in conjunction with the drawings and examples, but the teachings of the present disclosure are not limited to these disclosed examples. Based on the various examples above, those skilled in the art can understand that more embodiments can be obtained by combining the code review means in different examples described above, and these examples also fall within the scope of the present disclosure.

What is claimed is:

1. A visual alarm device comprising:
a light source;
a lens;
a processing module; and
a light sensing module;
wherein the light source and the light sensing module are both located on an inner side of the lens;
wherein the processing module is connected to the light sensing module;
wherein the lens transmits light emitted by the light source;
wherein the light sensing module senses light from the lens side when the light source is emitting light, and generates an illuminance signal indicating a light intensity of the sensed light, and sends the illuminance signal to the processing module;
wherein the processing module sends a first fault signal to a management terminal if it is determined that the light intensity sensed by the sensing module is greater than a first illuminance threshold according to the illuminance signal; and
wherein the first fault signal indicates the visual alarm device is blocked.

2. The visual alarm device as claimed in claim 1, wherein the light from the lens side comprises at least one of: light reflected from an inner surface of the lens, light emitted from an outer surface of the lens, and light transmitted from an outer side of the lens to the inner side of the lens.

3. The visual alarm device as claimed in claim 1, wherein:
the processing module sends a second fault signal to the management terminal if it is determined that the light intensity sensed by the sensing module is smaller than a second illuminance threshold according to the illuminance signal;
the second illuminance threshold is smaller than the first illuminance threshold and is used to indicate that the light source is faulty.

4. The visual alarm device as claimed in claim 3, wherein:
the light sensing module (comprises; at least two light sensors;
the at least two light sensors are arranged at different positions on the inner side of the lens;
the at least two light sensors are respectively connected to the processing module;
the at least two light sensors sense light from the lens side when the light source is emitting to generate an illuminance signal indicating a light intensity of the sensed light, and send the generated illuminance signal to the processing module; and
the processing module sends the first fault signal to the management terminal when the light intensity indicated by the illuminance signal sent by at least one of the light sensors is greater than the first illuminance threshold, and send the second fault signal to the management terminal when the light intensities indicated by the illuminance signals sent by both of the light sensors are smaller than the second illuminance threshold.

5. The visual alarm device as claimed in claim 4, wherein:
the outer side of the lens has a convex surface;
the inner side of the lens has a cross-shaped concave portion comprising a first groove and a second groove that are orthogonal to one another;
the light source is arranged in a cavity at an inspection of the first groove and the second groove;
the inner side of the lens comprises four refraction regions located between the first groove and the second groove; and
each of the refraction regions has at least one of the light sensors.

6. The visual alarm device as claimed in claim 5, wherein:
one of the light sensors is arranged on each of the refraction regions;
a light sensing surface of the light sensors faces the outer side of the lens; and
for each of the light sensors, an angle between a vertical line passing through the center of the light sensing surface of the light sensor and perpendicular to the light sensing surface and a normal at a point of intersection where the vertical line and the outer surface of the lens intersect is less than 15°.

7. The visual alarm device as claimed in claim 3, wherein:
the light sensing module comprises an annular light sensor;
the light source is arranged in an annular ring of the annular light sensor; and
a light sensing surface of the annular light sensor faces the outer side of the lens.

8. The visual alarm device as claimed in claim 1, wherein:
the light sensing module comprises: a DC power supply, a light sensor, an operational amplifier, a first resistor, a second resistor, a third resistor and an analog-to-digital converter;
the DC power supply is connected to an input terminal of the light sensor;
an output terminal of the light sensor is connected to an input terminal of the first resistor;
an output terminal of the first resistor is grounded;
a non-inverting input terminal of the operational amplifier is connected to the output terminal of the light sensor;
an inverting input terminal of the operational amplifier is connected to an input terminal of the second resistor;
an output terminal of the second resistor is grounded;
an input terminal of the third resistor is connected to an output terminal of the operational amplifier;
an output terminal of the third resistor is connected to the input terminal of the second resistor;
the output terminal of the operational amplifier is connected to an input terminal of the analog-to-digital converter; and
an output terminal of the analog-to-digital converter is connected to the processing module.

9. A method for detecting whether a visual alarm device is blocked, wherein the visual alarm device comprises a light source located on an inner side of a lens, the method comprising:
obtaining an illuminance signal indicating a light intensity of light from the lens side when the light source is emitting light; and
sending a first fault signal to a management terminal if it is determined that the light intensity of the light from the lens side is greater than a first illuminance threshold according to the illuminance signal;
wherein the first fault signal indicates the visual alarm device is blocked.

10. The method as claimed in claim 9, wherein the method further comprises
sending a second fault signal to the management terminal if it is determined that the light intensity of the light from the lens side is smaller than a second illuminance threshold according to the illuminance signal;
wherein the second illuminance threshold is smaller than the first illuminance threshold; and
the second fault signal indicates the light source is faulty.

11-12. (canceled)
